(19) United States
(12) Patent Application Publication
(10) Pub. No.: US 2009/0320782 A1
(43) Pub. Date: Dec. 31, 2009

(54) Ceramic Heater, Glow Plug and Method for Manufacturing Ceramic Heater

(75) Inventor: Norimitsu Hiura, Kagoshima (JP)

Correspondence Address: PROCOPIO, CORY, HARGREAVES & SAVITCH LLP, 530 B STREET, SUITE 2100, SAN DIEGO, CA, 92101, US

(73) Assignee: KYOCERA CORPORATION, Kyoto (JP)

(21) Appl. No.: 12/543,870

(22) Filed: Aug. 19, 2009

Related U.S. Application Data
(63) Continuation-in-part of application No. PCT/JP2008/053019, filed on Feb. 22, 2008.

(30) Foreign Application Priority Data
Feb. 22, 2007 (JP) 2007-041681

(51) Int. Cl. F23Q 7/00; H05B 3/00; H01C 17/02

(52) U.S. Cl. 123/145 A; 219/544; 29/611

(57) ABSTRACT

A ceramic heater and method of manufacturing of the ceramic heater are disclosed. A configuration and material composition of component parts of the ceramic heater allow the component parts to be formed together. Thereby, formation of cracks is reduced in a heat-generating resistor, leads, and a ceramic body. Uses of the ceramic heater may include an internal combustion engine glow plug.

### CROSS-REFERENCE TO RELATED APPLICATION

The present application is a continuation in part based on PCT Application No. JP2008/053019, filed on Feb. 22, 2008, which claims the benefit of Japanese Application No. 2007-041681, filed on Feb. 22, 2007 entitled “CERAMIC HEATER, GLOW PLUG AND CERAMIC HEATER MANUFACTURING METHOD”. The content of which are incorporated by reference herein in their entirety.

### FIELD OF THE INVENTION

Embodiments of the present invention relate generally to heaters, and more particularly relate to ceramic heaters.

### BACKGROUND

A ceramic heater usually has a structure in which a heat-generating resistor and leads for feeding the heat-generating resistor are arranged in a ceramic body. The ceramic heater is manufactured in such a manner that the heat-generating resistor and the leads are separately formed, arranged to partly overlap with each other, and then fired together with the ceramic body. This can result in the heat-generating resistor having significant misalignment with leads or stress applied thereto causing bumps on the heat-generating resistor. When the bumps have a sharp wedge shape, the bumps possibly cause cracks and/or the like in the heat-generating resistor and the leads.

Thus, there is a need for a ceramic heater in which the formation of such bumps is reduced and therefore formation of cracks is reduced in a heat-generating resistor, leads, or a ceramic body.

### SUMMARY

A ceramic heater and method of manufacturing of the ceramic heater are disclosed. A configuration and material composition of component parts of the ceramic heater allow the component parts to be formed together. Thereby, formation of cracks is reduced in a heat-generating resistor, leads, and a ceramic body. Uses of the ceramic heater may include an internal combustion engine glow plug.

A first embodiment comprises a ceramic body. The ceramic body comprises a resistor coupled to the ceramic body configured to generate heat. The resistor comprises a plurality of connecting portions coupled to a plurality of leads and has a width less than a width of the leads. The resistor also comprises a main portion. The leads are coupled to the ceramic body and are configured to supply electricity to the resistor. Each of the leads comprises a recessed portion located at end portions thereof that are coupled to each of the connecting portions and are open in a longitudinal direction and in a thickness direction of the leads. The connecting portions are partly located in recessed portions.

A second embodiment comprises a method for manufacturing a ceramic heater comprising a resistor configured to generate heat, a plurality of leads configured to supply electricity to the resistor, and a ceramic body comprising the resistor and the leads. The method comprises preparing a green form such that a first paste for the resistor and a second paste for the leads are provided on green ceramic sheets for the ceramic body such that at least one portion of the first paste is connected to the second paste. The method further comprises firing the green form such that the first paste comprises portions connected to the second paste. The first paste has a width less than a width of the second paste and the portions connected to the second paste are provided within the width of the second paste.

A third embodiment comprises a glow plug. The glow plug comprises a ceramic heater comprising a ceramic body and a resistor coupled to the ceramic body. The resistor is configured to generate heat and comprises a plurality of connecting portions coupled to a plurality of leads and has a width less than a width of the leads. The heater also comprises a main portion. The leads are coupled to the ceramic body and are configured to supply electricity to the resistor. Each of the leads comprises a recessed portion located at end portions thereof that are coupled to the connecting portions and are open in a longitudinal direction and in a thickness direction of the leads. The connecting portions are partly located in recessed portions.

### BRIEF DESCRIPTION OF THE DRAWINGS

Embodiments of the present invention are hereinafter described in conjunction with the following figures, wherein like numerals denote like elements. The figures are provided for illustration and depict exemplary embodiments of the invention. The figures are provided to facilitate understanding of the invention without limiting the breadth, scope, scale, or applicability of the invention. The drawings are not necessarily made to scale.

FIG. 1 illustrates a sectional view of an exemplary ceramic heater according to an embodiment of the present invention; the sectional view is perpendicular to a thickness direction of the ceramic heater.

FIG. 2A illustrates a sectional view of the embodiment shown in FIG. 1; the sectional view is perpendicular to a longitudinal direction of leads.

FIG. 2B illustrates an enlarged sectional view of a connecting portion and one of the leads shown in FIG. 2A in cross section.

FIG. 3 illustrates a sectional view, of the embodiment shown in FIG. 1, the sectional view is perpendicular to a width direction thereof.

FIG. 4 illustrates a sectional view, of a modification of the embodiment shown in FIG. 1; the sectional view is perpendicular to the width direction thereof.

FIG. 5 illustrates a sectional view of a ceramic heater according to an embodiment of the present invention; the sectional view is perpendicular to the longitudinal direction of the ceramic heater.

FIG. 6 illustrates a sectional view of a ceramic heater according to an embodiment of the present invention; the sectional view is perpendicular to the longitudinal direction of the ceramic heater.

FIG. 7A illustrates a sectional view of a heat-generating resistor according to a modification of the ceramic heater shown in FIG. 6; the sectional view is perpendicular to the longitudinal direction thereof.

FIG. 7B illustrates an enlarged sectional view of a connecting portion and lead shown in FIG. 7A in cross section.

FIG. 8 illustrates a sectional view of a ceramic heater according to an embodiment of the present invention; the sectional view is perpendicular to the longitudinal direction of the ceramic heater.

FIG. 9 illustrates a schematic sectional view of an exemplary glow plug according to an embodiment of the present invention.

FIG. 10A illustrates a sectional view of a conventional ceramic heater; the sectional view is perpendicular to the thickness direction of the conventional ceramic heater.

FIG. 10B illustrates a sectional view of the conventional ceramic heater; the sectional view is perpendicular to the longitudinal direction of the conventional ceramic heater.

FIG. 11 illustrates an exploded perspective view of a green form used in a method for manufacturing a ceramic heater according to an embodiment of the present invention.

### DETAILED DESCRIPTION OF EXEMPLARY EMBODIMENTS

The following description is presented to enable a person of ordinary skill in the art to make and use the embodiments of the invention. The following detailed description is exemplary in nature and is not intended to limit the invention or the application and uses of the embodiments of the invention. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the invention. Furthermore, there is no intention to be bound by any expressed or implied theory presented in the preceding technical field, background, brief summary or the following detailed description. The present invention should be accorded scope consistent with the claims, and not limited to the examples described and shown herein.

Embodiments of the invention are described herein in the context of practical non-limiting applications, namely, a diesel engine glow plug. Embodiments of the invention, however, are not limited to such glow plug applications, and the techniques described herein may also be utilized in other applications. For example, embodiments may be applicable to ignition heaters and the flame detection heaters that can be used in the form of, for example, combustion devices such as combustion-type car heaters and kerosene fan heaters. Sensor heaters that can be used in, for example, automotive glow plugs, and various sensors such as oxygen sensors. The sensing heaters are used in, for example, measuring instruments.

As would be apparent to one of ordinary skill in the art after reading this description, these are merely examples and the embodiments of the invention are not limited to operating in accordance with these examples. Other embodiments may be utilized and structural changes may be made without departing from the scope of the exemplary embodiments of the present invention.

The following description is presented to enable a person of ordinary skill in the art to make and use the embodiments of the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the embodiments of the present invention. Thus, the embodiments of the present invention are not intended to be limited to the examples described herein and shown, but are to be accorded the scope consistent with the claims.

In a ceramic heater according to an embodiment of the present invention, connecting portions having a width less than that of leads are located in recessed portions formed in the leads; hence, the connecting portions can be prevented from partly protruding. In this manner, thermal stress which is concentrated on a single site during rapid heating or cooling or during firing or usage is reduced. Thereby, formation of cracks is reduced near junctions between a heat-generating resistor and the leads or being formed in the heat-generating resistor, the leads, or a ceramic body. Therefore, the ceramic heater can be provided so as to be excellent in durability and reliability.

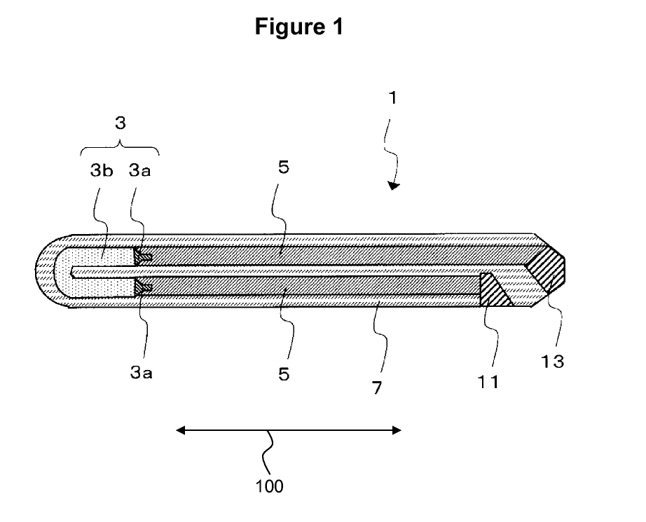

As shown in FIGS. 1 to 3, a ceramic heater 1 (hereinafter also referred to as the heater 1) according to an embodiment of the present invention comprises a heat-generating resistor 3, leads 5 for supplying electricity to the heat-generating resistor 3, and a ceramic body 7 comprising the heat-generating resistor 3, and the leads 5. The heat-generating resistor 3 comprises connecting portions 3a each connected to each of the leads 5 respectively.

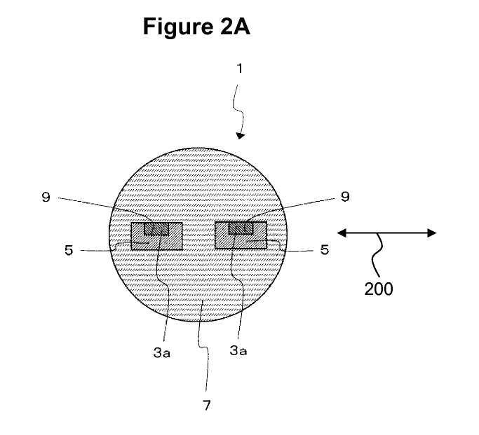

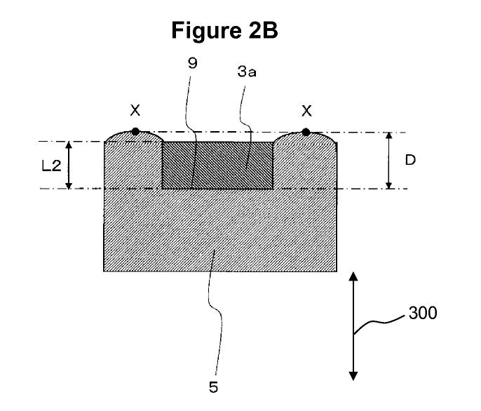

According to one embodiment, the heat-generating resistor 3 may comprise one connecting portion 3a connected to each of the lead 5. In FIGS. 1 and 2, the heat-generating resistor 3 comprises two connecting portions 3a and each is connected to each of two leads 5. Each of the connecting portions 3a has a width less than that of the leads 5. The heat-generating resistor 3 also comprises a main heat-generating portion 3b other than the connecting portions 3a. Each of the leads 5 comprises a recessed portion 9 located at each end connected to the connecting portions 3a. Each of the recessed portions 9 is open in the longitudinal direction and thickness direction of the leads 5. The connecting portions 3a are partly located in the recessed portions 9.

In this embodiment, a longitudinal direction, a thickness direction, and a width direction are defined as described below. As shown in FIG. 1, the longitudinal direction 100 is defined, as a direction parallel to a line from one end of each of the leads 5, to an opposite end of each of the leads 5. As shown in FIG. 2A, the width direction 200 is defined as a direction parallel to a line that connects centers of the leads 5, which are adjacent to each other, in cross section perpendicular to junctions between the connecting portions 3a and the leads 5. As shown in FIG. 2B, the thickness direction 300 is defined as a direction that is perpendicular to the width direction and the longitudinal direction.

In this embodiment, a thickness and a width mean a distance measured in the thickness direction and a distance measured in the width direction, respectively. A width D (FIG. 2B) of each recessed portion 9 is defined as the maximum distance, in the thickness direction, between a surface portion of the recessed portion 9 and a line connecting two peaks X sandwiching the recessed portion 9 as shown in FIG. 2B, the two peaks X being portions of a corresponding one of the leads 5.

The leads 5 comprise recessed portions 9, which are open in the longitudinal direction and the thickness direction, and the connecting portions 3a are partly located in the recessed portions 9. In this manner bumps are reduced from being formed on the heat-generating resistor 3, which are connected to the leads 5. Therefore, such crack formation as described above is reduced because thermal stresses concentrated on junctions between the heat-generating resistor 3 and the leads 5 is reduced when the heat-generating resistor 3 and the leads 5 are rapidly heated or cooled during firing or usage.

The heat-generating resistor 3 is electrically connected to an anode-side electrode 13 and a cathode-side electrode 11 through the leads 5 and is further electrically connected to an external power supply (not shown) through the anode-side electrode 13 and the cathode-side electrode 11. Heat can be generated from the heat-generating resistor 3 in such a manner when a voltage is applied to the heat-generating resistor 3 from the external power supply.

As shown in FIG. 1, the connecting portions 3a preferably have a width less than that of the main heat-generating portion 3b. In this manner, a possibility of formation of cracks in the ceramic body 7 can be reduced. In particular, the main heat-generating portion 3b can be designed to have a small thickness if the main heat-generating portion 3b is designed to have a uniform cross-sectional area and a large width such that a desired amount of heat is achieved.

A ceramic heater is generally manufactured in such a manner that a paste for the heat-generating resistor 3 and a paste for the leads 5 are sandwiched between a plurality of ceramic sheets for the ceramic body 7. In this embodiment, an adhesion between the ceramic sheets can be enhanced because a thickness of the main heat-generating portion 3b can be set to be small. Therefore, the possibility of the formation of cracks in the ceramic body 7 can be reduced.

In particular, the connecting portions 3a preferably have a width equal to 30% to 80% of that of the main heat-generating portion 3b. If the connecting portions 3a have a width equal to 30% or more of that of the main heat-generating portion 3b, the strength of junctions between the main heat-generating portion 3b and the connecting portions 3a can be enhanced. If the connecting portions 3a have a width equal to 80% or less than that of the main heat-generating portion 3b, the adhesion between the ceramic sheets can be enhanced.

On the other hand, when the connecting portions 3a have a width equal to that of the main heat-generating portion 3b, printing yield can be increased. This is because the heat-generating resistor 3 can be formed so as to have a constant width. Since the heat-generating resistor 3 has a simple shape when having such a constant width, the entire heat-generating resistor 3 can be readily formed by printing. This is effective in increasing printing yield.

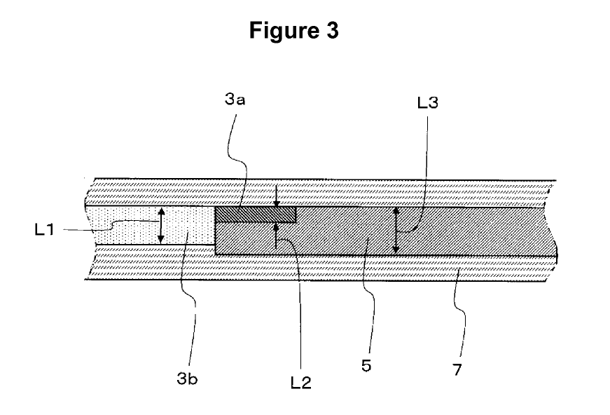

As shown in FIG. 3, it is effective that the connecting portions 3a have a thickness less than that of the main heat-generating portion 3b. This is because the difference between the thickness of the main heat-generating portion 3b and the thickness of the leads 5. Therefore, the adhesion between the main heat-generating portion 3b, the leads 5, and the ceramic body 7 can be enhanced. In this manner, the main heat-generating portion 3b, the leads 5, and the ceramic body 7 can be prevented from being separated from each other.

In particular, the connecting portions 3a preferably each has a thickness L2 equal to 40% to 95% of the thickness L1 of the main heat-generating portion 3b. When the connecting portions 3a each has a thickness L2 equal to 40% or more than the thickness L1 of the main heat-generating portion 3b, the bonding strength between the leads 5 and the connecting portions 3a can be enhanced. When the connecting portions 3a each has a thickness L2 equal to 95% or less than the thickness L1 of the main heat-generating portion 3b, the connecting portions 3a can be readily placed in the recessed portions 9. This enhances adhesion between the connecting portions 3a and leads 5.

On the other hand, printing yield can be increased when the connecting portions 3a each has a thickness L2 equal to the thickness L1 of the main heat-generating portion 3b. This is because the heat-generating resistor 3 can be formed so as to have a constant thickness. Since the heat-generating resistor 3 has a simple shape when having such a constant thickness, all of the heat-generating resistor 3 can be readily formed by printing. This is effective in increasing printing yield.

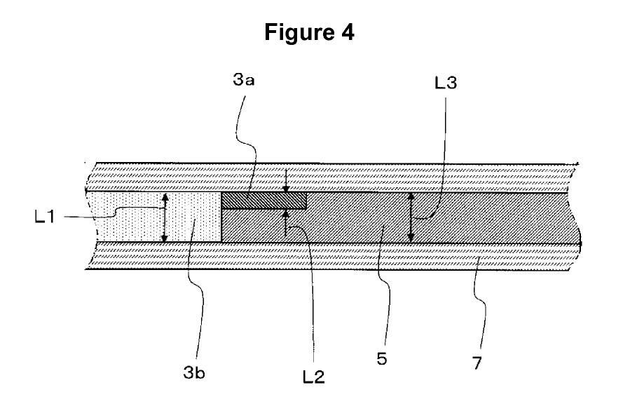

As shown in FIG. 4, it is effective that the main heat-generating portion 3b has a thickness L1 substantially equal to the thickness L3 of each of the leads 5. The smaller the difference in thickness between the main heat-generating portion 3b and the leads 5, the smaller the difference in level between the main heat-generating portion 3b and the leads 5. Since there is substantially no difference in level between the main heat-generating portion 3b and the leads 5 when the main heat-generating portion 3b has a thickness L1 substantially equal to the thickness L3 of each of the leads 5, the main heat-generating portion 3b and the leads 5 can be readily provided in the ceramic body 7. In this manner, the leads 5 can be prevented from being misaligned with the heat-generating resistor 3. The fact that the main heat-generating portion 3b and the leads 5 have substantially the same thickness means that the difference in thickness between the main heat-generating portion 3b and the leads 5 is less than the thickness variation of the main heat-generating portion 3b and the thickness variation of the leads 5.

The connecting portions 3a preferably have a thickness less than that of the leads 5. This allows the heat-generating resistor 3 to have high resistance. The increase of the resistance of the heat-generating resistor 3 allows the main heat-generating portion 3b to efficiently generate heat and is effective in preventing the temperature of the leads 5 from being increased; hence, the durability of the ceramic heater 1 can be enhanced.

In particular, the connecting portions 3a preferably have a thickness L2 equal to 5% to 50% of the thickness L3 of each of the leads 5 as shown in FIGS. 3 and 4. When the connecting portions 3a each has a thickness L2 equal to 5% or more than the thickness L3 of each of the leads 5, the bonding strength between the leads 5 and the connecting portions 3a can be enhanced. When the connecting portions 3a each has a thickness L2 equal to 50% or less than the thickness L3 of each of the leads 5, the connecting portions 3a can be stably placed in the recessed portions 9. This is effective in preventing the connecting portions 3a from protruding out of the recessed portions 9; hence, bumps can be prevented from being formed on the connecting portions 3a.

The connecting portions 3a is preferably substantially quadrilateral in cross section perpendicular to the longitudinal direction as shown in FIG. 2B. When the connecting portions 3a is substantially quadrilateral in cross section, the recessed portions 9 can be large. Therefore, the connecting portions 3a can be prevented from protruding out of the recessed portions 9; hence, the possibility of the formation of bumps on the connecting portions 3a is low. In this manner, formation of cracks can be reduced from being formed near the connecting portions 3a.

The heat-generating resistor 3 may be made, for example and without limitation, of a carbide, nitride, or silicide of W, Mo, Ti, or the like. In particular, the heat-generating resistor 3 is preferably made of WC in view of the thermal expansion coefficient, heat resistance, and resistivity thereof.

The heat-generating resistor 3 preferably comprises boron nitride. A conductive component contained in the heat-generating resistor 3 usually has a thermal expansion coefficient greater than that of a ceramic component, such as silicon nitride, contained in the ceramic body 7. This causes stress between the heat-generating resistor 3 and the ceramic body 7. On the other hand, boron nitride has a thermal expansion coefficient less than that of a ceramic component such as silicon nitride and hardly reacts with the conductive component in the heat-generating resistor 3. This allows the heat-generating resistor 3 to have a small thermal expansion coefficient without significantly varying heat-generating properties of the heat-generating resistor 3.

In particular, the content of boron nitride is preferably 4% to 20% by weight. When the boron nitride content is 4% by weight or more, the thermal stress generated between the heat-generating resistor 3 and the ceramic body 7 can be reduced because the heat-generating resistor 3 has a small thermal expansion coefficient.

When the boron nitride content is 20% by weight or less, the variation in resistance of the heat-generating resistor 3 can be reduced. This allows the resistance of the heat-generating resistor 3 to be stable without significantly varying heat-generating properties of the heat-generating resistor 3. The boron nitride content is more preferably 12% by weight or less.

It is effective that the heat-generating resistor 3 comprises the ceramic component, such as silicon nitride, contained in the ceramic body 7. When the heat-generating resistor 3 comprises the ceramic component, the difference between the thermal expansion coefficient of the heat-generating resistor 3 and that of the ceramic body can be reduced. When the ceramic component is silicon nitride, the heat-generating resistor 3 preferably comprises 10% to 40% by weight silicon nitride.

The leads 5 may be made of, for example but without limitation, a carbide, nitride, or silicide of W, Mo, Ti, or the like. In particular, the leads 5 are preferably made of WC in view of the thermal expansion coefficient, heat resistance, and resistivity thereof.

It is more preferred that the leads 5 be made of WC and comprise 15% to 40% by weight silicon nitride. When the leads 5 comprise 15% by weight or more silicon nitride, the difference between the thermal expansion coefficient of the leads 5 and the thermal expansion coefficient of the ceramic body can be reduced and therefore formation of cracks can be reduced between the leads 5 and the ceramic body. When the leads 5 contain 40% by weight or less silicon nitride, the resistance of the leads 5 can be prevented from being increased significantly. The content of silicon nitride therein is further more preferably 20% to 35% by weight.

The leads 5 and the heat-generating resistor 3 preferably comprise the same main component, which allows the adhesion between the heat-generating resistor 3 and the leads 5 to be enhanced. In this manner, the possibility of the formation of cracks in junctions between the heat-generating resistor 3 and the leads 5 can be reduced.

The ceramic body 7 may be made of, for example but without limitation, an insulating ceramic material such as an oxide ceramic material, a nitride ceramic material, or a carbide ceramic material. In particular, a ceramic material made of silicon nitride is preferably used. This is because the use of the ceramic material made of silicon nitride is effective in enhancing strength, toughness, electric insulation, and heat resistance.

Such a ceramic material can be obtained as described below. Silicon nitride, which is a main component, is mixed with 3% to 12% by weight of a rare-earth element oxide, such as but without limitation, Y₂O₃, Yb₂O₃, or Er₂O₃, serving as a sintering aid; 0.5% to 3% by weight Al₂O₃; and 1.5% to 5% by weight SiO₂. The mixture is formed into a predetermined shape and then fired at 1650° C. to 1780° C. by hot pressing.

When the ceramic body 7 comprises silicon nitride, MoSiO₂ and/or WSi₂ is preferably dispersed therein, which allows the ceramic body 7 to have an increased thermal expansion coefficient. Hence, the difference in thermal expansion coefficient between the ceramic body 7 and the heat-generating resistor 3 can be reduced. In this manner, the durability of the ceramic heater 1 can be enhanced.

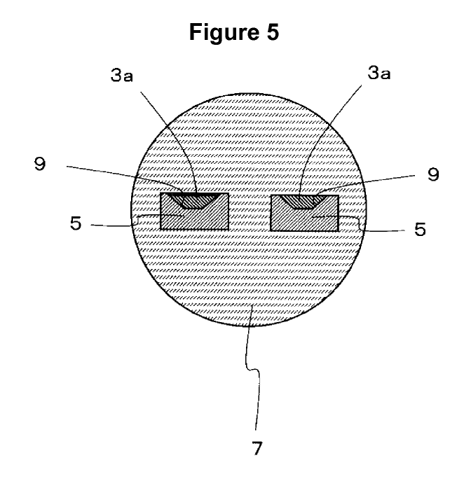

According to another embodiment, connecting portions 3a are trapezoidal in cross section perpendicular to the longitudinal direction as shown in FIG. 5. Since the connecting portions 3a are trapezoidal in cross section, a possibility of the formation of cracks in the heat-generating resistor 3 or leads 5 can be reduced more than that described in the embodiment described above and shown in FIG. 2A. The reason for this is as follows.

The thermal expansion of a heat-generating resistor 3 causes thermal stress between the heat-generating resistor 3 and recessed portions 9 present in the leads 5. In the embodiment shown in FIG. 2A, the recessed portions 9 connected to the connecting portions 3a have side surfaces parallel to each other and therefore the directions of the thermal stresses applied to the parallel side surfaces of the recessed portions 9 are opposite to each other; hence, it is difficult to disperse the thermal stresses applied thereto. However, in the embodiment shown FIG. 5, the connecting portions 3a are trapezoidal and therefore such thermal stresses can be dispersed in the thickness direction (the vertical direction in FIG. 5). In this manner, thermal stresses can be dispersed, thereby the heat-generating resistor 3 and the leads 5 can have a reduced number of cracks.

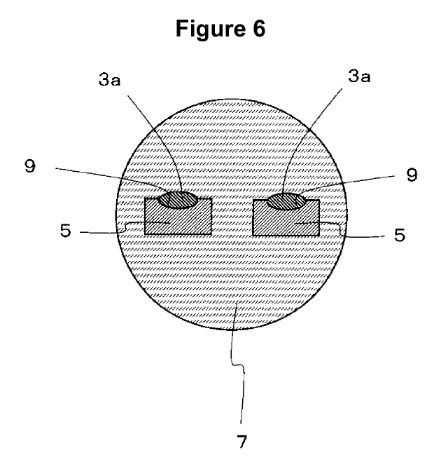

According to another embodiment, recessed portions 9 are curved in cross section perpendicular to the width direction as shown in FIG. 6. In other words, surfaces of connecting portions 3a that are connected to the recessed portions 9 are curved. This reduces thermal stresses locally concentrated on the connecting portions 3a as compared to the first embodiment; hence, the possibility of the formation of cracks in the connecting portions 3a or the recessed portions 9 can be reduced.

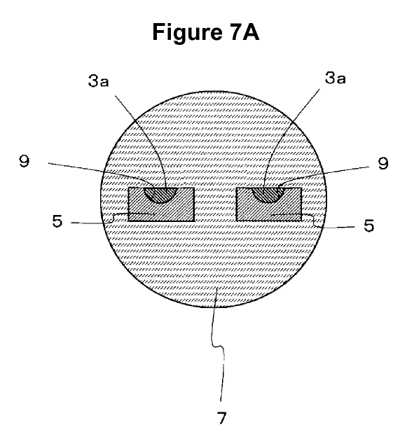

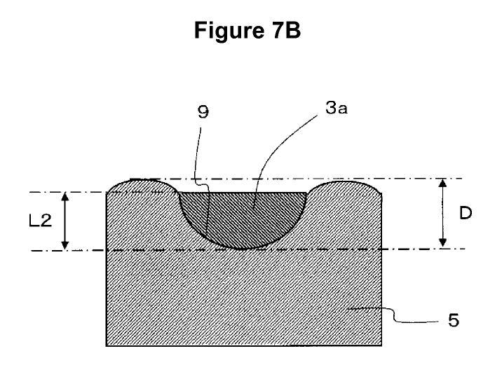

In particular, the recessed portions 9 are preferably substantially arced in cross section perpendicular to the longitudinal direction shown in FIGS. 7A and 7B. This allows thermal stress to be substantially uniformly dispersed; hence, thermal stresses locally concentrated on the connecting portions 3a are reduced. This results in that the connecting portions 3a and the recessed portions 9 can have a reduced number of cracks.

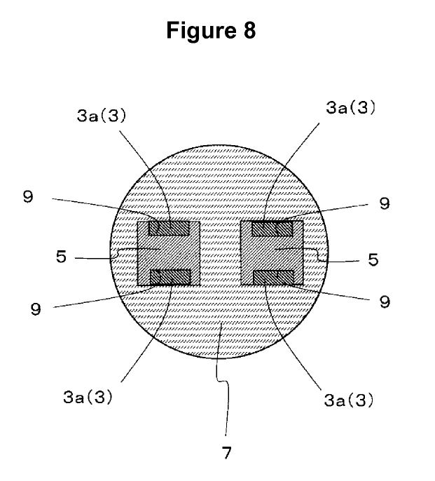

According to another embodiment, leads 5 have recessed portions 9 which are located at ends connected to two heat-generating resistors 3 and which are located at positions opposed to each other and the heat-generating resistors 3 each have connecting portions 3a partly located in the recessed portions 9 as shown in FIG. 8. Therefore, the symmetry in temperature distribution between a portion and another portion of each heat-generating resistor 3 that are spaced from each other in the thickness direction is good; hence, the temperature variation of a heater 1 in the thickness direction during usage can be reduced. In this manner, the heat-generating resistor 3 can have a reduced number of cracks; thereby, the ceramic heater 1 has enhanced durability.

When the leads 5 each have the two recessed portions 9, the connecting portions 3a, which are located in the recessed portions 9, preferably have substantially the same cross-sectional area. This allows the difference between the heat generated from one of the heat-generating resistors 3 and the heat generated from the other one to be reduced; hence, the difference between thermal stresses can be reduced.

In the above embodiments, the heat-generating resistors 3 preferably have a resistivity greater than the resistivity of the leads 5. When the heat-generating resistors 3 have a resistivity greater than the resistivity of the leads 5, the resistance of the heat-generating resistors 3 can be adjusted to be greater than the resistance of the leads 5 without increasing the size of the heater 1. This allows the heat-generating resistors 3 to efficiently generate heat, thereby allowing the rapid heating of the ceramic heater 1. Furthermore, the cathode-side electrodes 11 and the anode-side electrodes 13 can be prevented from being increased in temperature; hence, properties of the heater 1 can be enhanced. The heat-generating resistors 3 can be measured for resistivity as described below.

When the cross-sectional area of each heat-generating resistor 3 is constant in the plane perpendicular to the longitudinal direction, the heat-generating resistor 3 is measured for resistance (mΩ), cross-sectional area (mm2), and length (mm). The resistance thereof can be measured with a milliohm meter.

When the cross-sectional area of the heat-generating resistor 3 is not constant in the plane perpendicular to the longitudinal direction, the heat-generating resistor 3 may be machined with a surface grinder so as to have a shape with a cross-sectional area constant in an arbitrary direction. A useful example of the surface grinder is a surface grinder equipped with a KSK-type #250 diamond wheel. Examples of such a shape with a cross-sectional area constant in an arbitrary direction include a prismatic shape and a cylindrical shape.

The machined heat-generating resistor 3 may be measured for resistance (mΩ), cross-sectional area (mm2), and length (mm). The resistivity ρ(Ω·μm) (=resistance×cross-sectional area/length) thereof can be determined from the resistance, cross-sectional area, and length thereof. The leads 5 can be determined for resistivity by substantially the same method as that used to determine the resistivity of the heat-generating resistor 3.

The connecting portions 3a are preferably entirely located in the recessed portions 9. When the connecting portions 3a are entirely located in the recessed portions 9, the possibility of the formation of bumps on the connecting portions 3a can be reduced. In this manner, formation of cracks is reduced near the connecting portions 3a; hence, the ceramic heater 1 has high durability and reliability. The fact that the connecting portions 3a are entirely located in the recessed portions 9 means that the recessed portions 9 have a depth D greater than the thickness L2 of each of the connecting portions 3a.

The heat-generating resistors 3 have the main heat-generating portions 3b and the connecting portions 3a located at the ends of the main heat-generating portions 3b. The main heat-generating portions 3b preferably have a small thickness relatively to the width thereof, that is, the main heat-generating portions 3b are preferably flat in cross section perpendicular to the longitudinal direction. This allows the main heat-generating portions 3b to have a large perimeter in cross section perpendicular to the longitudinal direction and also allows the main heat-generating portions 3b to have a small thickness; hence, printing can be readily performed. Therefore, printing yield can be increased.

In particular, the main heat-generating portions 3b preferably have an elliptical shape, with the minor axis in the thickness direction, in cross section perpendicular to the longitudinal direction. When the main heat-generating portions 3b have such a shape, the main heat-generating portions 3b have a large width and a small thickness. When the main heat-generating portions 3b are elliptical in cross section, the main heat-generating portions 3b have curved surfaces; hence, thermal stresses locally concentrated on the main heat-generating portions 3b can be reduced.

The main heat-generating portions 3b preferably have substantially a uniform width. When the main heat-generating portions 3b are uniform in width, the main heat-generating portions 3b can be readily formed; hence, printing yield can be increased. Furthermore, narrow portions thereof can be prevented from locally generating heat; hence, the ceramic heater 1 has enhanced durability. In particular, the narrowest portions of the main heat-generating portions 3b preferably have a width equal to 70% or more of that of the widest portions of the main heat-generating portions 3b. When the narrowest portions have a width equal to 70% or more of that of the widest portions, the narrowest portions can be prevented from locally generating heat.

The main heat-generating portions 3b preferably have substantially a uniform thickness. When the main heat-generating portions 3b are uniform in thickness, the main heat-generating portions 3b can be readily formed; hence, printing yield can be increased. Furthermore, thin portions thereof can be prevented from locally generating heat; hence, the ceramic heater 1 has enhanced durability. In particular, a thinnest portion of each of the main heat-generating portions 3b preferably has a thickness equal to 80% or more of that of the thickest portions of the main heat-generating portions 3b. When the thinnest portions have a width equal to 80% or more of that of the thickest portions, the thinnest portions can be prevented from locally generating heat.

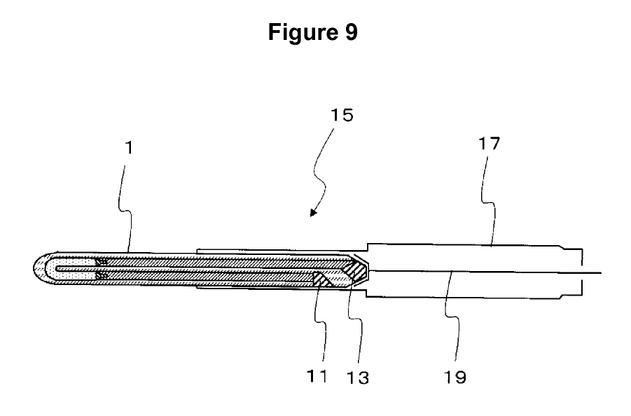

FIG. 9 illustrates a glow plug 15 according to an embodiment of the invention. The plug glow may comprise a ceramic heater 1 typified by that according to any one of the above embodiments, a first metal member 17 which is cylindrical and in which an end portion of the ceramic heater 1 is located, and a second metal member 19 which is located in the first metal member 17 so as to be spaced from the first metal member 17 and which is connected to the ceramic heater 1. The heater 1 comprises a cathode-side electrode 11 on a side surface thereof and an anode-side electrode 13 at an end thereof. The cathode-side electrode 11 is electrically connected to the first metal member 17. The anode-side electrode 13 is electrically connected to the second metal member 19.

When the second metal member 19 and the first metal member 17 are supplied with electricity, the glow plug 15 can function as a heat source for engine starting. Since the glow plug 15 includes the ceramic heater 1, the glow plug 15 has enhanced durability and reliability. Even if the glow plug 15 is used in cold climates, the glow plug 15 can start an engine in a shorter time as compared with conventional glow plugs.

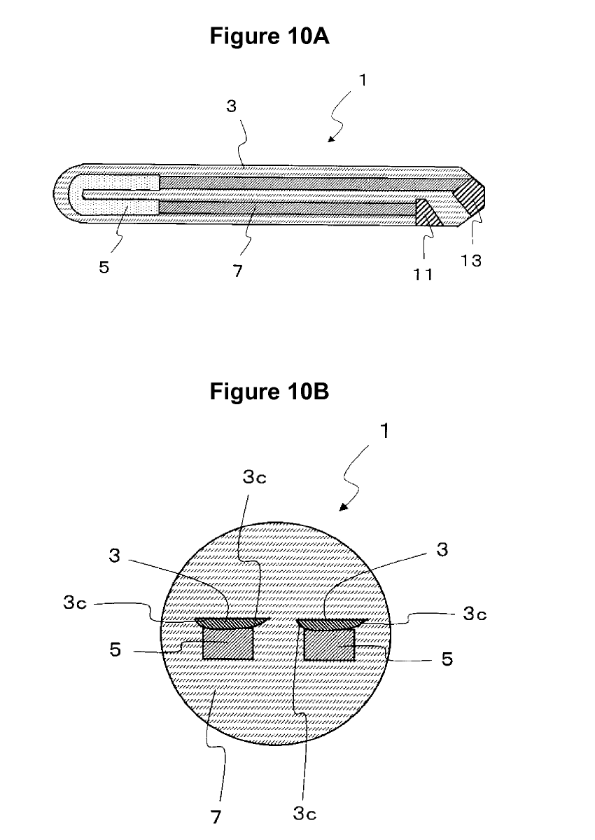

As shown in FIGS. 10A and 10B, in an existing manufacturing process for a ceramic heater, a heat-generating resistor 3 is significantly misaligned with leads 5 or the stress applied thereto causes bumps 3c on the heat-generating resistor 3. When the bumps 3c have a sharp wedge shape, the bumps possibly causes cracks and/or the like in the heat-generating resistor and the leads. In contrast, formation of such cracks are significantly reduced or eliminated according to a ceramic heater-manufacturing method of an embodiment of the present invention as described below.

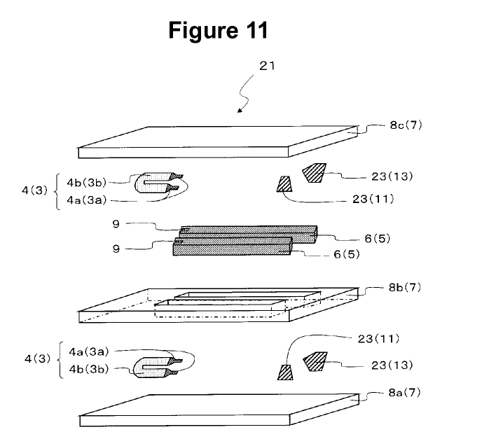

FIG. 11 illustrates an exploded perspective view of a green form used in a ceramic heater-manufacturing method a ceramic heater according to an embodiment of the present invention. The ceramic heater-manufacturing method comprises preparing a green form 21 in such a manner that a first paste 4 for a heat-generating resistor 3 and a second paste 6 for leads 5 are provided on green ceramic sheets for a ceramic body 7 and a step of firing the green form 21. The first paste 4 has portions (hereinafter referred to as the connecting paste portions 4a) connected to the second paste 6. The connecting paste portions 4a have a width less than that of the second paste 6 and are provided within the width of the second paste 6.

In particular, the first paste 4 is provided on the green ceramic sheets 8a and 8c by printing as shown in FIG. 11. In this operation, the first paste 4 is provided on the sheets by printing such that the connecting paste portions 4a have a width less than the width of the second paste 6. The width of connecting portions 3a can be readily adjusted to be less than the width of the leads 5 in such a manner that plate making and a press mold are designed such that the width of the connecting paste portions 4a is less than the width of the second paste 6. A third paste 23 for an anode-side electrode 13 and a cathode-side electrode 11 may be provided on the green ceramic sheets 8a and 8c by printing.

It is preferred that grooves be formed, in advance, in portions of the green ceramic sheets 8a and 8c that are to be provided with the first paste 4 and the first paste 4 be provided in the grooves. This is effective in reducing the occurring of the misalignment of the first paste 4.

The second paste 6 is provided on the green ceramic sheet 8b by printing. It is preferred that a groove or hole be formed, in advance, in a portion of the green ceramic sheet 8b that is to be provided with the second paste 6 and the second paste 6 be provided in the groove or hole. This is effective in reducing the occurring of the misalignment of the second paste 6.

The green form 21 is prepared in such a manner that the green ceramic sheets 8a and 8c provided with the first paste 4 and the green ceramic sheet 8b provided with the second paste 6 are stacked such that the connecting paste portions 4a are provided within the width of the second paste 6. The green form 21 is fired at a temperature of 1650° C. to 1780° C. by hot pressing to obtain the ceramic heater 1.

The use of the ceramic heater-manufacturing method of this embodiment reduces occurring of bumps on the connecting portions 3a. This results in that the possibility of the formation of cracks in the ceramic body 7, the heat-generating resistor 3, or the leads 5 is reduced.

The ceramic heater 1, which is rectangular parallelepiped-shaped after being fired, may be subjected to centerless grinding so as to be cylindrical. The ceramic heater 1 can be manufactured so as to have such a shape as shown in FIG. 1 in such a manner that an end portion and another end portion of the ceramic heater 1 are machined with a diamond wheel machined into a desired shape in advance.

The green ceramic sheets 8a and 8c provided with the first paste 4 and the green ceramic sheet 8b provided with the second paste 6 are stacked. These sheets may be stacked as described below.

The first paste 4 is provided on the green ceramic sheets 8a and 8c by printing. The second paste 6 is provided on the green ceramic sheets 8a and 8c by printing. The green ceramic sheets 8a and 8c provided with the first paste 4 and the second paste 6 are stacked with the green ceramic sheet 8b.

If the first paste 4 and the second paste 6 are provided on the green ceramic sheets 8, which are of the same type, and the green ceramic sheets 8 are then stacked, the first paste 4 and the second paste 6 can be prevented from being misaligned with each other.

The width of the first paste 4 is preferably adjusted such that the connecting paste portions 4a have a width less than that of another portion (hereinafter referred to as the main heat-generating paste portion 4b). This is because in order to achieve a desired amount of heat, the main heat-generating portion 3b can be designed to have a small thickness by increasing the width of the main heat-generating paste portion 4b. The reduction of the thickness of the main heat-generating portion 3b allows the adhesion between the green ceramic sheets to be enhanced. When the main heat-generating portion 3b has a small thickness, the main heat-generating portion 3b can be readily printed; hence, printing yield can be increased.

In particular, the connecting paste portions 6b preferably have a width equal to 30% to 80% of the width of the main heat-generating paste portion 6a. When the connecting paste portions 6b have a width equal to 30% or more of the width of the main heat-generating paste portion 6a, the strength of the boundaries between the main heat-generating portion 3b and the connecting portions 3a can be enhanced. Furthermore, the contact area between the connecting paste portions and the second paste is increased; hence, the bonding strength between the connecting portions 3a and the leads 5 can be enhanced. When the connecting paste portions 6b have a width equal to 80% or less of the width of the main heat-generating paste portion 6a, the adhesion between the ceramic sheets can be enhanced.

It is effective that the connecting paste portions 4a have a thickness less than that of the main heat-generating paste portion 4b. This is because the difference in thickness between the main heat-generating portion 3b and the leads 5 can be reduced. This prevents the main heat-generating portion 3b and the leads 5 from being separated from the ceramic body 7.

In particular, the connecting paste portions 4a preferably have a thickness equal to 40% to 95% of the thickness of the main heat-generating paste portion 4b. When the connecting paste portions 4a have a thickness equal to 40% or more of the thickness of the main heat-generating paste portion 4b, the bonding strength between the second paste 6 and the connecting paste portions 4a can be enhanced. When the connecting paste portions 4a have a thickness equal to 95% or less of the thickness of the main heat-generating paste portion 4b, the connecting paste portions 4a can be readily placed in recessed portions 9. This allows the connecting paste portions 4a and the second paste 6 to be securely connected to each other.

The connecting paste portions 4a preferably have a thickness less than that of the second paste 6. This is because the resistance of the heat-generating resistor 3 can be increased. The increase of the resistance of the heat-generating resistor 3 allows the main heat-generating portion 3b to efficiently generate heat.

In particular, the connecting paste portions 4a preferably have a thickness equal to 5% to 50% of the thickness of the second paste 6. When the connecting paste portions 4a have a thickness equal to 5% or more of the thickness of the second paste 6, the bonding strength between the second paste 6 and the connecting paste portions 4a can be enhanced. When the connecting paste portions 4a have a thickness equal to 50% or less of the thickness of the second paste 6, the connecting paste portions 4a can be entirely placed in recessed portions 9 stably. This is effective in preventing the connecting paste portions 4a from protruding out of the recessed portions 9; hence, the possibility of the formation of bumps on the connecting portions 3a can be reduced.

It is preferred that the second paste 6 has the recessed portions 9 and the first paste 4 is connected to the second paste 6 in the recessed portions 9. When the second paste 6 has the recessed portions 9, the misalignment of the connecting paste portions 4a can be prevented; hence, the connecting paste portions 4a can be stably provided in the recessed portions 9.

The recessed portions 9 can be formed by press molding using, for example but without limitation, a mold with a predetermined shape. In particular, the following mold may be used: a mold designed such that the recessed portions 9 are formed in end portions of the second paste 6 so as to be open in the longitudinal direction and the thickness direction.

The leads 5 can be formed so as to have the recessed portions 9, which are open in the longitudinal direction and the thickness direction, in such a manner that the second paste 6 press-molded with the mold is provided on the green ceramic sheets 8 and then fired.

### EXAMPLES

The ceramic heater 1 of the above embodiment was prepared as described below. A mixture was prepared by adding an oxide of Yb and MoSi₂ to a powder made of silicon nitride (Si₃N₄). The Yb oxide was used as a sintering aid. MoSi₂ was used to adjust the thermal expansion coefficient of green ceramic sheets close to the thermal expansion coefficient of heat-generating resistors 3 and leads 5. The mixture was press-molded into the green ceramic sheets 8.

A first paste 4, a second paste 6, and a third paste 23 for electrode lead portions were prepared. For adhesion enhancement, the first paste 4, the second paste 6, and the third paste 23 prepared from the same material made of WC and boron nitride. The first paste 4 and third paste 23 were provided on the green ceramic sheets 8 by printing.

The first paste 4 was provided thereon so as to vary in width and thickness as shown in FIG. 12 below. In particular, the first paste 4 was provided thereon such that a main heat-generating portion 3b had a width of 0.6 to 1.0 mm and a thickness of 0.10 to 0.25 mm and connecting portions 3a had a width of 0.6 to 1.0 mm and a thickness of 0.07 to 0.19 mm.

The second paste 6 was provided on the green ceramic sheets 8 by printing. In this operation, the second paste 6 was provided thereon such that the leads 5 had a width of 1.0 mm and a thickness of 1.0 mm. In Samples 3 to 15, recessed portions 9 were formed in end portions of the leads 5 with a press mold so as to be open in the longitudinal direction and the thickness direction, the end portions being connected to the connecting portions 3a. The recessed portions 9 had a depth D of 0.20 mm. The recessed portions 9 were quadrilateral (FIG. 2A), tapered (FIG. 5), curved (FIG. 6), or substantially arced (FIG. 7A).

The green ceramic sheets 23 provided with the second paste 6 were deposited on the green ceramic sheets 8 provided with the first paste 4 and the third paste 23. Green forms 21 were prepared as described above.

Each green form 21 was provided in a cylindrical carbon mold and then fired at a temperature of 1650° C. to 1780° C. and a pressure of 30 to 50 MPa in a reducing atmosphere by hot pressing, whereby a sintered body was obtained. Electrode members were brazed to a cathode-side electrode 11 and anode-side electrode 13 exposed at the surface of the sintered body, whereby the ceramic heater 1 was prepared.

In this example, the heat-generating resistors 3 and the leads 5 were measured for resistivity by a procedure below. Sintered bodies were prepared from a material for the heat-generating resistors 3 and a material for the leads 5. Each sintered body was ground into a 3-mm square prism with a length of 18 mm using a surface grinder equipped with a #250 diamond wheel. Electrodes were formed on both end surfaces of the sintered body by printing and then baked in a vacuum furnace.

The sintered body was measured for resistance R (mΩ) in such a manner that a constant current was applied between the electrodes at room temperature. The resistivity ρ(Ω μm) (=resistance (R)×cross-sectional area/length=R/2) thereof was calculated from the resistance thereof.

In this example, the heat-generating resistors 3 had a resistivity of 1.6Ω μm to 2.5Ω μm and the leads 5 had a resistivity of 2.5Ω μm. The reason why these sintered bodies were prepared from the material for the heat-generating resistors 3 in this example is to readily measure the resistivity.

FIG. 12 summarizes the width, thickness, and resistivity of the main heat-generating portions 3b, connecting portions 3a, and leads 5 of the samples.

The ceramic heater 1 was subjected to a heat cycle durability test below. The ceramic heater 1 was supplied with electricity for 30 seconds, whereby the ceramic body 7 was heated such that the surface temperature of the ceramic body 7 was increased from room temperature up to 1300° C. The resulting ceramic heater 1 was air-cooled for 60 seconds, whereby the surface temperature of the ceramic body 7 was decreased to room temperature. The ceramic heater 1 was heated and cooled for 140000 cycles. The surface temperature of the ceramic body 7 may be measured with a radiation thermometer. The resistance of the ceramic heater 1 was adjusted such that the voltage applied to the ceramic heater 1 to maintain the ceramic heater 1 at 1300° C. was 190 V to 210 V.

As shown in FIGS. 12 and 13, samples including main heat-generating portions 3b and connecting portions 3a having different widths, thicknesses, resistivities, and shapes were evaluated for printing yield. The fired samples were evaluated for cracks. The samples subjected to the heat cycle test were evaluated for cracks. The samples were observed with an optical microscope at a magnification of 450 times whether cracks were present or not.

Forty ceramic heaters 1, having a thickness of 2 mm, a width of 6 mm, and a length of 50 mm, for test use were prepared for each sample. Twenty of the heaters were fired by hot pressing and then evaluated for cracks, whereby the incidence of cracks was determined. The remaining 20 heaters subjected to the heat cycle durability test and then evaluated for cracks, whereby the incidence of cracks was determined. The evaluation results are summarized in FIG. 13.

As is clear from the results shown in FIGS. 12 and 13, Samples 1 and 2 have sharp wedge-shaped bumps protruding in the width direction because the connecting portions 3a of the heat-generating resistors 3 were formed so as to have the same width as that of the leads 5. Therefore, the ceramic body 7 has a high crack incidence of 60% or more.

On the other hand, the ceramic heaters 1 of Samples 3 to 15 have a crack incidence of 20% or less. This confirms that the crack incidence thereof is greatly improved because the connecting portions 3a have a width less than that of the leads 5 and therefore the thermal stresses applied thereto are reduced.

In Samples 5 to 7, 10, and 12, the recessed portions 9 are curved or substantially arced, the leads have the recessed portions located in end portions which are connected to the connecting portions 3a and which are opposed to each other, and the connecting portions are entirely located in the recessed portions. Cracks are hardly present in Samples 5 to 7, 10, and 12, which are fired or subjected to the durability test. This shows that the ceramic heaters have significantly enhanced durability.

Samples 4 and 11, in which the main heat-generating portions 3b have a large thickness, have a relatively small printing yield of 60% to 70%. This is probably because, since the main heat-generating portions 3b have a large thickness and therefore are forced to be printed, the difference in thickness therebetween is large. In particular, Sample 4, in which the connecting portions 3a have a width greater than that of the main heat-generating portion 3b, has a low printing yield of 60%. Samples 3, 4, and 11, in which the connecting portions 3a have a large thickness, have relatively high crack incidence. This is because the connecting portions 3a are badly located in the recessed portions 9 of the leads 5.

Samples 14 and 15, in which the connecting portions 3a of the heat-generating resistors 3 have the same width as that of the main heat-generating portions 3b, have an extremely large printing yield of 100%. This is because the heat-generating resistors 3, which have a constant width, are simple in shape and therefore can be readily formed.

While at least one exemplary embodiment has been presented in the foregoing detailed description, the present invention is not limited to the above-described embodiment or embodiments. Variations may be apparent to those skilled in the art. In carrying out the present invention, various modifications, combinations, sub-combinations and alterations may occur in regard to the elements of the above-described embodiment insofar as they are within the technical scope of the present invention or the equivalents thereof. The exemplary embodiment or exemplary embodiments are examples, and are not intended to limit the scope, applicability, or configuration of the invention in any way. Rather, the foregoing detailed description will provide those skilled in the art with a template for implementing the exemplary embodiment or exemplary embodiments. It should be understood that various changes can be made in the function and arrangement of elements without departing from the scope of the invention as set forth in the appended claims and the legal equivalents thereof. Furthermore, although embodiments of the present invention have been described with reference to the accompanying drawings, it is to be noted that changes and modifications may be apparent to those skilled in the art. Such changes and modifications are to be understood as being included within the scope of the present invention as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A ceramic heater, comprising:
a ceramic body;
a lead having a width, a longitudinal direction, a thickness direction, and an end portion; and
a resistor in the ceramic body configured to generate heat, the resistor comprising:
a connecting portion coupled to the lead and having a width less than the width of the lead; and
a main portion,
wherein the lead is coupled to the ceramic body and is configured to supply electricity to the resistor, and
wherein the lead comprises a recessed portion which is located at the end portion thereof, which is coupled to the connecting portion, and which is open in the longitudinal direction and in the thickness direction of the lead, and at least a part of the connecting portion is located in the recessed portion.

2. The ceramic heater according to claim 1, wherein the main portion has a width, and the connecting portion has a width less than the width of the main portion.

3. The ceramic heater according to claim 1, wherein the main portion has a thickness, and the connecting portion has a thickness less than a thickness of the main portion.

4. The ceramic heater according to claim 1, wherein the lead has a thickness, and the connecting portion has a thickness less than a thickness of the lead.

5. The ceramic heater according to claim 1, further including a junction between the connecting portion and the lead, and the junction is curved.

6. The ceramic heater according to claim 5, wherein the recessed portion is substantially arced in cross section, perpendicular to the longitudinal direction.

7. The ceramic heater according to claim 1, wherein the lead has a resistivity, and the resistor has a resistivity that is at least one of greater than a resistivity of the lead and equal to a resistivity of the lead.

8. The ceramic heater according to claim 1, wherein each lead includes the recessed portion located at the end portion of the lead that is connected to the connecting portion, the end portions of respective leads being opposed to each other, and the resistor includes the connecting portion located in respective recessed portions.

9. The ceramic heater according to claim 1, wherein the connecting portion is entirely located in the recessed portion.

10. A method for manufacturing a ceramic heater comprising a resistor configured to generate heat, a lead configured to supply electricity to the resistor, and a ceramic body comprising the resistor and the lead, the method comprising:
preparing a green form such that a first paste for the resistor and a second paste for the lead are provided on green ceramic sheets for the ceramic body such that at least one portion of the first paste is connected to the second paste; and
firing the green form such that the first paste comprises portions connected to the second paste and which have a width less than a width of the second paste and the portions connected to the second paste are provided within the width of the second paste.

11. The ceramic heater-manufacturing method according to claim 10, wherein the width of the first paste is adjusted such that the portions connected to the second paste have a width less than a width of other portions.

12. The ceramic heater-manufacturing method according to claim 10, wherein the first paste is such that the portions connected to the second paste have a thickness less than a thickness of other portions.

13. The ceramic heater-manufacturing method according to claim 10, wherein the first paste is such that the portions connected to the second paste have a thickness less than the thickness of the second paste.

14. The ceramic heater-manufacturing method according to claim 10, wherein the second paste has a recessed portion and the first paste extends in the recessed portion and is coupled to the second paste.

15. A glow plug comprising:
a ceramic heater comprising:
a ceramic body;
a lead having a width, a longitudinal direction, a thickness direction, and an end portion; and
a resistor in the ceramic body configured to generate heat, the resistor comprising:
a connecting portion coupled to the lead and having a width less than the width of the lead; and
a main portion,
wherein the lead is coupled to the ceramic body and is configured to supply electricity to the resistor, and
wherein the lead comprises a recessed portion which is located at the end portion thereof, which is coupled to the connecting portion, and which is open in the longitudinal direction and in the thickness direction of the lead, and at least a part of the connecting portion is located in the recessed portion.

16. The glow plug of claim 15, wherein the ceramic heater includes an end portion, and the glow plug further comprising:
a first cylindrical metal member locating outside of the end portion of the ceramic heater; and
a second metal member coupled to the ceramic heater, located in the first metal member and spaced from the first metal member.

17. The glow plug of claim 15, wherein the connecting portion is at least one of substantially quadrilateral, and trapezoidal in cross section.

18. The glow plug of claim 15, wherein the recessed portion is at least one of substantially arced, quadrilateral, tapered, curved, and arced.
